(19) United States
(12) Patent Application Publication
(10) Pub. No.: US 2026/0317535 A1
(43) Pub. Date: Oct. 15, 2026

(54) LOW FILLER EPOXY RESIN COMPOSITIONS

(71) Applicant: SolEpoxy, Inc., Olean, NY (US)

(72) Inventors: Meghan E. SMITH, Kane, PA (US); Donald Arthur Burkhart, Escondido, CA (US)

(21) Appl. No.: 19/465,314

(22) Filed: Jan. 30, 2026

Related U.S. Application Data
(60) Provisional application No. 63/752,674, filed on Feb. 1, 2025.

(51) Int. Cl. C08L 63/00; C08K 3/40

(52) U.S. Cl. CPC C08L 63/00; C08K 3/40; C08L 2201/10; C08L 2203/206

(57) ABSTRACT

The present disclosure relates to an unreacted intermediate encapsulant composition, including an epoxy resin component comprising an epoxy resin blend and at least one curing agent, the epoxy resin blend comprising a mixture of at least a first epoxy-based resin and a second epoxy-based resin, wherein the first epoxy-based resin is a cycloaliphatic epoxy resin; optionally a filler component; and at least one polyol. Also described herein is a partially cured molding compound, a cured compound, an encapsulant material for electronic components, a device, and an assembly including the same. Further described herein are methods of preparing a partially cured molding compound and a cured device.

### CROSS REFERENCE TO RELATED APPLICATIONS

This application claims priority to U.S. Provisional Application No. 63/752,674 filed Feb. 1, 2025, the entire contents of which is herein incorporated by reference in its entirety.

### FIELD OF THE INVENTION

The present disclosure relates to a curable, optically clear, non-yellowing, translucent epoxy resin composition comprising a filler content no more than 25% by weight of the total uncured composition, yielding reduced moisture absorption, high regular transmission and total transmission, high elongation, high toughness, high flex strength, and a low coefficient of thermal expansion, a cured product comprising the same, and a method for making the same.

### BACKGROUND

Cured products comprising epoxy resin compositions have versatile applications due to their superior adhesive, chemical, thermomechanical, and electrically insulating properties. Uses of epoxy resin-based cured products span a wide variety of fields, including electric and electronic applications, optical applications, aerospace and automotive applications. More specific uses for curable epoxy compositions include use as encapsulants for optoelectronic devices such as LEDs, photodetectors, and fiber optic and semiconductor components, sensors, and light emitters.

Epoxy resin compositions useful in encapsulating optoelectronic devices such as LEDs may involve liquid type compositions, which can be filled or poured about an LED and cured. Additionally, partially cured epoxy compositions may be used for encapsulating LEDs, in which an epoxy composition is partially cured or “B-staged” to form a “pellet”, which can then be transfer molded with the electronic device under heat and pressure to encapsulate the LED.

Recent market trend towards miniaturization of high-performance optoelectronic devices has led to a demand for epoxy resin compositions with high flexibility, high strength, and minimal moisture absorption for encapsulating a semiconductor chip. To ensure that electronic components are suitable for use in sophisticated manufacturing networks, the industry has adopted the Joint Electronic Device Engineering Council (JEDEC) Solid State Technology Association's standardization pertaining to Moisture Sensitivity Levels (MSL), typically requiring a minimum MSL level 3 or 4. Many, if not most, semiconductor devices require the highest level of robustness, i.e., MSL 1.

MSL is an indication whether a device may be stored in a hot and humid environment, assembled into a circuit board, and then flash heated at 260 degrees) (° C. for soldering without causing the device to crack or apply damaging stress to its encapsulated electronic elements. Neat epoxy resins perform poorly with respect to MSL because epoxy will absorb moisture and they have a coefficient of thermal expansion (CTE) that is typically much higher than those of the encapsulated electronic devices. By way of example, the CTE for a typical epoxy is 80 parts per million/degree Celsius (ppm/° C.), whereas the CTE for copper is about 16.7 ppm/° C. and that for silicon is about 2.6 ppm/° C.

Semiconductor manufacturers have implemented the use of rapid screening tests for moisture absorption to predict MSL. While standard materials screening for MSL can take over one thousand hours, other methods, such as water boil testing, can produce results under accelerated conditions.

Those skilled in the art recognize that composite materials made of epoxy and glass are well known in the art. Previous attempts have been made to develop an optically clear epoxy with high RTRAN, low CTE and low moisture absorption. For example, it is well known in the art to modify epoxy resins intended for electrical encapsulation with inorganic fillers, such as silica and metal oxides, to reduce the CTE and moisture absorption (MSL) of the resulting composition. However, for optoelectronic applications in particular, the addition of filler typically has a negative impact upon optical properties such as clarity, and may also negatively impact glass transition temperature (Tg), modulus, elongation, and flexural properties. For example, low CTE materials tend to be stiff and less ductile, and therefore are not optimal within thinner packaging, that requires high toughness and flexibility.

However, despite these previous attempts, optoelectronic device manufacturers continue to search for clear encapsulants with high RTRAN, low CTE, and high flex strength, and which also possess improved durability inasmuch as they can sustain the high temperatures required for surface mount application and lead-free soldering where at a minimum MSL level 3 would be required, MSL 1 being the most desirable. Thus, a need remains for an optoelectronic device encapsulant compositions with robust optical properties (such as high regular transmittance and high total transmittance), as well as low CTE, low moisture absorption, and robust flexural properties.

### SUMMARY OF THE INVENTION

Briefly, embodiments of the present invention provide a low filler, high-performance, thermoset epoxy resin composition with high transmittance (regular—RTRAN—and total—TTRAN), high flex strength and elongation, low MSL, and low CTE. The present invention may address one or more of the problems and deficiencies of the art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

Certain embodiments of the presently disclosed encapsulation composition, articles or devices related to the same, and/or methods for forming the encapsulation composition, have several features, no single one of which is solely responsible for their desirable attributes.

Without limiting the scope of the composition, articles, devices and methods as defined by the claims that follow, their more prominent features will now be discussed briefly.

After considering this discussion, and particularly after reading the section of this specification entitled “Detailed Description of the Invention,” one will understand how the features of the various embodiments disclosed herein provide several advantages over the current state of the art.

In an aspect of the invention, an unreacted intermediate encapsulant composition is provided, including: an epoxy resin component including an epoxy resin blend and at least one curing agent, the epoxy resin blend including a mixture of at least a first epoxy-based resin and a second epoxy-based resin, wherein the first epoxy-based resin is a cycloaliphatic epoxy resin; a filler component; and at least one polyol.

In some embodiments, the cycloaliphatic epoxy resin is a low viscosity cycloaliphatic epoxy resin. In some embodiments, the low viscosity cycloaliphatic epoxy resin has a viscosity of about of less than 1000 cps at 25° C. In some embodiments, the low viscosity cycloaliphatic epoxy resin has a viscosity of about 700 cps to about 900 cps at 25° C. In some embodiments, the low viscosity cycloaliphatic epoxy resin is monocyclic. In some embodiments, the low viscosity cycloaliphatic epoxy resin is a cycloaliphatic glycidyl ester.

In an aspect of the invention, a partially cured molding compound is provided, the partially cured molding compound including an unreacted intermediate encapsulant composition, wherein the unreacted intermediate encapsulant composition is partially cured thereby forming the partially cured molding compound, and wherein the unreacted intermediate encapsulant composition includes: an epoxy resin component including an epoxy resin blend and at least one curing agent, the epoxy resin blend including a mixture of at least a first epoxy-based resin and a second epoxy-based resin, wherein the first epoxy-based resin is a cycloaliphatic epoxy resin; a filler component; and at least one polyol.

In some embodiments, the partially cured molding compound is prepared by B-staging the unreacted intermediate encapsulant composition, thereby forming the partially cured molding compound.

In an aspect of the invention, a cured compound is provided, the cured compound including an unreacted intermediate encapsulant composition, wherein said unreacted intermediate encapsulant composition is cured, thereby forming a cured compound, and wherein the unreacted intermediate encapsulant composition includes: an epoxy resin component including an epoxy resin blend and at least one curing agent, the epoxy resin blend including a mixture of at least a first epoxy-based resin and a second epoxy-based resin, wherein the first epoxy-based resin is a low viscosity cycloaliphatic epoxy resin; a filler component; and at least one polyol.

In some embodiments, the cured compound has a regular transmission of light (RTRAN) greater than about 65% and more preferably greater than about 80%, over light wavelengths from about 30 nm to about 2500 nm when measured in a 1.0 mm thick sample of the cured compound.

In an aspect of the invention, an encapsulant material for electronic components is provided, the encapsulant material for electronic components including a partially cured molding compound, the partially cured molding compound including an unreacted intermediate encapsulant composition, wherein the unreacted intermediate encapsulant composition is partially cured thereby forming the partially cured molding compound, and wherein the unreacted intermediate encapsulant composition includes: an epoxy resin component including an epoxy resin blend and at least one curing agent, the epoxy resin blend including a mixture of at least a first epoxy-based resin and a second epoxy-based resin, wherein the first epoxy-based resin is a low viscosity cycloaliphatic epoxy resin; a filler component; and at least one polyol.

In an aspect of the invention, a device including an optoelectronic element encapsulated by the encapsulant material for electronic components is provided.

In an aspect of the invention, an assembly is provided, the assembly including a device, the device including an optoelectronic element encapsulated by the encapsulant material for electronic components.

In an aspect of the invention, a method of preparing a partially cured molding compound is provided, the method including: a) providing an epoxy component comprising an epoxy resin blend and an anhydride component, wherein the epoxy resin blend comprises a mixture of at least a first epoxy-based resin and a second epoxy-based resin, where the first epoxy-based resin is a cycloaliphatic epoxy resin; b) mixing a filler component with said epoxy component; c) adding at least one polyol thereby producing an unreacted intermediate encapsulant composition; and d) increasing the viscosity of the unreacted intermediate encapsulant composition by partially curing said encapsulant composition to an initial viscosity capable of maintaining said filler component suspended throughout the encapsulant composition, thereby forming a partially cured molding compound.

In an aspect of the invention, a method of preparing a cured device is provided, the method including the steps of:
providing an unreacted intermediate encapsulant composition, said unreacted intermediate encapsulant composition including:
   an epoxy resin component including an epoxy resin blend and at least one curing agent, the epoxy resin blend comprising a mixture of at least a first epoxy-based resin and a second epoxy-based resin, wherein the first epoxy-based resin is a cycloaliphatic epoxy resin;
   a filler component; and
   at least one polyol;
preparing a partially cured molding compound, wherein preparing includes B-staging the unreacted intermediate encapsulant composition;
providing an optoelectronic component;
encapsulating the optoelectronic component with the partially cured molding compound to form a curable device; and
curing the curable device with time or heat, thereby forming a cured device.

The foregoing is illustrative only and is not intended to be in any way limiting. In addition to the illustrative aspects, embodiments, and features described above, further aspects, embodiments, and features will become apparent from the following detailed description of the various aspects of the invention taken in conjunction with the appended claims and the accompanying drawings.

### BRIEF DESCRIPTION OF THE FIGURES

The present invention will hereinafter be described in conjunction with the following figures.

FIG. 1 is a graphical representation of the relationship between wavelength (nm) and RTRAN of a liquid epoxy resin composition prepared in the manner described herein.

FIG. 2 is a graphical representation of the % weight loss and % weight gain of a liquid epoxy resin composition prepared in the manner described herein.

FIG. 3 is a graphical representation of the % wt. moisture over time of a liquid epoxy resin composition prepared in the manner described herein.

### DETAILED DESCRIPTION OF THE TECHNOLOGY

It should be understood, that for the purposes of the present disclosure, the following terms have the following meaning:

As used herein, the expression “cured” composition or product refers to a product that results from fully curing a curable composition. Additionally, as used herein, the expression “fully curing” refers to curing the curable composition to a degree of cure such that subsequent exposure of the resultant cured product to temperatures at or above the original cure temperature, with the exception of temperatures high enough to melt or decompose the cured product, will not materially alter the physical properties of the cured product beyond those achieved by the original curing process.

As used herein, the expression “partially cured” composition refers to an epoxy resin composition wherein the epoxy resin is about 40% to about 60% cured.

As used herein, the expression “B-staged” refers to a resin composition that is partially cured.

As used herein, the expression “transparent” means having an RTRAN of 80% or more, and “substantially transparent” means having an RTRAN of 70% or more.

The “particle size” of the filler component is measured by methods known to persons of ordinary skill in the art and as set forth in ISO 13320:2020 Standard.

As used herein, the expression “about” means+/−5%. Aspects of the present invention and certain features, advantages, and details thereof, are explained more fully below with reference to the non-limiting embodiments illustrated in the accompanying drawings. Descriptions of well-known materials, fabrication tools, processing techniques, etc., are omitted so as to not unnecessarily obscure the invention in detail. It should be understood, however, that the detailed description and the specific example(s), while indicating embodiments of the invention, are given by way of illustration only, and are not by way of limitation. Various substitutions, modifications, additions and/or arrangements within the spirit and/or scope of the underlying inventive concepts will be apparent to those skilled in the art from this disclosure.

In the following, the preferred embodiments of the inventive composition will be set out in more detail. It is to be understood that these technical details and embodiments also apply to all of the inventive products and processes.

In an aspect of the invention, an unreacted intermediate encapsulant composition is provided, including: an epoxy resin component including an epoxy resin blend and at least one curing agent, the epoxy resin blend including a mixture of at least a first epoxy-based resin and a second epoxy-based resin, wherein the first epoxy-based resin is a cycloaliphatic epoxy resin; optionally, a filler component; and at least one polyol.

In some embodiments, the unreacted intermediate encapsulant composition does not include a filler component. In some embodiments, the unreacted intermediate encapsulant composition includes a filler component. The filler component may include a glass filler and the glass filler may be clear or substantially clear.

The unreacted intermediate encapsulant composition is curable, i.e., capable of forming a cured compound, wherein the cured compound is substantially transparent or transparent. The cured compound is suitable for electronic, optical, and/or various other applications relating to, but not limited to, devices and uses thereof by manufacturers searching for transparent or substantially transparent encapsulation materials capable of sustaining high temperatures and temperature cycling, and that will not impart thermal stresses on the various components of the device.

The cured compound may also be suitable for applications where the degree of transparency is not as critical (i.e. automotive applications) as the material is capable of sustaining high temperatures and temperature cycling, and may also protect the encapsulated electronic elements from damaging stress.

In some embodiments, the epoxy resin component of the unreacted intermediate encapsulant composition is a reaction product of an anhydride of a cyclic dibasic acid and an epoxy resin blend. In some embodiments, the epoxy resin blend includes a first epoxy-based resin and a second epoxy-based resin. The first epoxy-based resin may be any thermosetting epoxy resin, and preferably (although optionally) one which is capable of being B-staged. Non-limiting examples of epoxy-based resins include solid and liquid epoxy resins derived from cycloaliphatic, aliphatic, bisphenol A or F, tetramethyl and/or biphenyl, naphthalene, and epichlorohydrin, novalacs, and the like. In certain embodiments, the epoxy resin blend comprises triglycidyl isocyanurate (TGIC), or reactants thereof. In other embodiments, the epoxy resin blend comprises a binary epoxy mixture of triglycidyl isocyanurate (TGIC), sold under the tradename TEPIC® by Nissan Chemical Industries, Ltd. The chemical structure of triglycidyl isocyanurate (TGIC) is as follows:

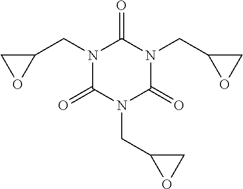 [SMILES: O=c1n(CC2CO2)c(=O)n(CC2CO2)c(=O)n1CC1CO1]

### 1,3,5-Triglycidyl isocyanurate, or 1,3,5-Tris(oxiran-2-ylmethyl)-1,3,5-triazinane-2,4,6-trione

The epoxy resin component may further comprise a curing agent (i.e. a curative or hardener), for example, an anhydride, as a reactant. In preferred embodiments, the anhydride comprises a first anhydride. More specifically, the first anhydride comprises a cyclic acid anhydride as a curing agent. The cyclic acid anhydride may be a cycloaliphatic anhydride (a/k/a/an anhydride of a cyclic dibasic acid), such as hexahydrophthalic anhydride (HHPA). In some embodiments, although not required, the epoxy resin component may include at least one second anhydride as a reactant. The at least one second anhydride may be a cyclic acid anhydride, such as tetrahydrophthalic anhydride, phthalic anhydride, or combinations thereof. In some embodiments, the amount of the at least one second anhydride is less than the amount of the first anhydride.

A second anhydride may be present as a reactant with the first anhydride, the second anhydride being less than 50 wt % of the total anhydride content, e.g., 0 to 50 wt %, including all values, ranges and subranges therein. For example, in some embodiments, the total anhydride content may comprise 50.5, 51, 55, 60, 65, 70, 75, 80, 85, 90, 95, 100 wt % of a first anhydride, including any and all values, ranges and subranges therein; and further may comprise 0, 5, 10, 15, 20, 25, 30, 35, 40, 45, 49, 49.5, 50 wt % of at least one second anhydride, including any and all values, ranges and subranges therein. For purposes of this disclosure, the total anhydride content equals the first anhydride plus the at least one second anhydride (to the extent there is any present).

Additional examples of curing agents in accordance with the invention include phthalic anhydride, maleic anhydride, methylnadic anhydride, nadic anhydride, trimellitic anhydride, phenolic novolac resin hardeners, methylhexahydrophthalic anhydride, tetrahydrophthalic anhydride, methyl tetrahydrophthalic anhydride, succinic anhydride, nonenyl succinic anhydride, glutaric anhydride, polyazelaic polyanhydride, polysebacic polyanhydride, pyromellitic anhydride, pyromellitic dianhydride, 3,3′,4,4′-Benzophenonetetracarboxylic dianhydride, etrachlorophthalic anhydride, dodecenyl succinic anhydride, 1,2,4,5-Benzenetetracarboxylic anhydride, and the like, either alone, or mixtures or blends of two or more.

Optionally, in order to promote reaction of the anhydride hardener and the epoxy resin blend by opening the anhydride ring, a ring opening agent can be used. In some embodiments, various ring opening agents known in the art can be incorporated into the epoxy component to assist in this ring opening reaction. Such ring opening can be accomplished, for example, by active hydrogens present as water, or by hydroxyls, or by a Lewis base.

In some embodiments, the unreacted intermediate encapsulant composition comprises a first polyol. The first polyol may assist in the ring opening of the anhydride and promote curing of the epoxy composition. In some embodiments, the first polyol is a lower aliphatic polyol of 3 to 8 carbon atoms and 2 to 4 hydroxyls, preferably of 3 hydroxyls. For example, and in accordance with the invention, both the first polyol and the second polyol may be selected from the group comprising glycerin, neopentyl glycol (NPG) and trimethylol propane (TMP), either alone or a mixture thereof. In some embodiments, although not required, the polyol comprises smaller proportions of at least one second polyol blended in with the first polyol, provided that the second polyol(s) do not adversely affect the encapsulant properties.

Although the reactions to make the unreacted intermediate encapsulant composition, and subsequently to cure the same, may be effected without a catalyst (or accelerator), in certain embodiments, the presence of a catalyst in the unfilled epoxy component of the curable encapsulant composition may be useful to speed up the reaction (in particular when an anhydride is used as the hardener). As such, in some embodiments, the unreacted intermediate encapsulant composition comprises a catalyst, wherein the catalyst comprises a relatively small group of catalytic materials, namely tin soaps of fatty acids of 8 to 18 carbon atoms. These catalytic materials may exert a catalytic effort without impairing the clarity, colorless nature, and other desirable properties of the encapsulant and the finished cured product. In other embodiments, alternate catalysts may be used, selected from the group comprising triethylenediamine, triphenylphosphite (TPP), imidazole derivatives (2-ethyl-4-methylimidazole and 2-methylimidazole), 1,8-Diazabicyclo[5.4.0]undec-7-ene (i.e. “DBU”), Hycat AO-4, Zinc Octoate, tertiary amines, quaternary ammonium salts, bases and acids, and mixtures or blends thereof.

Other than the epoxy resin blend, the anhydride, and optionally the polyol for ring opening and/or a catalyst, the presence of large proportions of other materials or modifiers in the epoxy component is avoided, so as to assure maintenance of the clarity and other properties of the resulting cured polymer product. In certain embodiments, however, small proportions of additional adjuvants (i.e. modifiers) which have specific desirable effects are acceptable. For example, in some embodiments, the epoxy component may comprise at least one modifier, wherein the at least one modifier is a mold release agent, wherein the mold release agent is selected from the group comprising higher fatty acids of 12 to 20 carbon atoms, or lower alcohol (1 to 3 carbon atoms) esters thereof, preferably saturated, or mixtures thereof. By way of example only, in preferred embodiments, stearic acid, myristic acid, palmitic acid or methyl stearate are utilized because they are very effective in easily releasing the cured product from the mold. In yet another embodiment of the invention, the epoxy component may comprise at least one modifier, wherein the at least one modifier is a silane, wherein the silane comprises no more than 0.5 weight percent of the total weight of the encapsulant composition.

In a preferred embodiment in accordance with the invention, the proportions of the various components of the unfilled epoxy component are such as to produce the monoester of the acid anhydride and have the glycidyl moiety of the triglycidyl isocyanurate react with the acid group resulting from the anhydride-polyol reaction. Of course, in the present reactions, it is possible that a molecule of polyol may react with both carboxyls which may be considered to have come from the anhydride, or polyol hydroxyls from different polyol molecules may each react with the carboxyls. Similarly, more than one glycidyl moiety of the triglycidyl isocyanurate may react with anhydride carboxyls and, in some cases, such reactions may be effected before the anhydride reacts with polyol. However, in most instances, the reactions may be considered to be those as initially described, with a polyol forming a monoester with an acid anhydride and a glycidyl moiety of triglycidyl isocyanurate reacting with a free carboxylic acid group generated by the previous reaction. Such reactions may be considered to be effected when the three reactants are simultaneously reacted.

In preferred embodiments of the invention, while not required, each of the reactants that make up the epoxy component will have a substantially low coloration and will be essentially pure, over 95% pure, preferably over 99% pure, and most preferably 99.9 to 100% pure. Additionally, the epoxy component of the unreacted intermediate encapsulant composition will comprise reactants that are clean and colorless (or substantially colorless), and have a low water content (i.e. water content<0.3%).

Additionally, one of ordinary skill in the art will recognize that the epoxy resin blend in the epoxy component may be cured with other types of epoxy hardeners or curing agents, modifiers, or catalysts to achieve the required index-matched composition, without the use of an anhydride or polyol. Such non-limiting examples of curing agents include isocyanuric acid derivatives and phenolic curing agents, or mixtures thereof. Such non-limiting examples of catalysts include amines, imidazoles, polyamides, metal salts such as zinc octoate, organophosphates, urea, formaldehyde, and various acids and bases and adducts thereof.

In addition to the unfilled epoxy component (which comprise the base epoxy resin, curing agent and optional ring opening agents, catalysts or other modifiers), the curable encapsulant comprises an inorganic filler to produce a filled encapsulant composition. As disclosed herein, the curable, filled encapsulant composition comprises a refractive index-matched filler material.

In some embodiments, the filled, epoxy composition is a substantially transparent epoxy composition, which when cured, is capable of transmitting light for an LED, sensor, lens, waveguide, light pipe, transmitter, receiver, and various other optical devices, as is known in the art. The curable encapsulant composition may take various forms, including but not limited to, liquid, solid, coating, encapsulant, underfill, or die attach adhesive.

Examples of an inorganic filler material include inorganic filler materials including silicon oxide, sodium oxide, and calcium oxide, as described in U.S. Pat. No. 10,611,911.

In an aspect of the invention, an unreacted intermediate encapsulant composition is provided, including: an epoxy resin component including an epoxy resin blend and at least one curing agent, the epoxy resin blend including a mixture of at least a first epoxy-based resin and a second epoxy-based resin, wherein the first epoxy-based resin is a low viscosity cycloaliphatic epoxy resin; a filler component; and at least one polyol.

In some embodiments, the cycloaliphatic epoxy resin is a low viscosity cycloaliphatic epoxy resin. The low viscosity cycloaliphatic epoxy resin may have a viscosity of about 1000 cps at 25° C. or lower. In some embodiments, the low viscosity cycloaliphatic epoxy resin has a viscosity of about 700 cps to about 900 cps, including all ranges, subranges, and values therein (e.g., about 700 cps, about 750 cps, about 800 cps, about 850 cps, about 900 cps, about 700 cps to about 750 cps, about 750 cps to about 800 cps, about 800 cps to about 850 cps, about 850 cps to about 900 cps, about 700 cps to about 800 cps, about 800 cps to about 900 cps, etc.) at 25° C. The low viscosity cycloaliphatic epoxy resin may be monocyclic. In some embodiments, the low viscosity cycloaliphatic epoxy resin is a cycloaliphatic glycidyl ester. Non-limiting examples of the first epoxy-based resin include triglycidyl isocyanurate (TGIC), Bisephenol A (BPA), a TGIC variant, a BPA variant, or combinations thereof.

In some embodiments, the second epoxy-based resin is a cycloaliphatic epoxy resin that is different from the first epoxy-based resin. In some embodiments, the second epoxy-based resin is Epalloy® 5000 (i.e., the diepoxide of the hydrogenated bisphenol A).

In some embodiments, the epoxy resin blend includes about 15 wt % to about 63 wt %, including all ranges, subranges, and values therein (e.g., about 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63 wt %, and/or about 19 wt % to about 25 wt %, about 25 wt % to about 50 wt %, about 50 wt % to about 63 wt %, about 20 wt % to about 40 wt %, about 40 wt % to about 60 wt %, etc.) of the cycloaliphatic epoxy resin and about 19 wt % to about 75 wt %, including all ranges, subranges, and values therein (e.g., about 19 wt %, about 25 wt %, about 30 wt %, about 37 wt %, about 50 wt %, about 75 wt %, about 19 wt % to about 37 wt %, about 37 wt % to about 50 wt %, about 50 wt % to about 75 wt %, about 20 wt % to about 40 wt %, about 40 wt % to about 60 wt %, etc.) of the second epoxy-based resin blend, based on the total weight of the epoxy resin blend.

In some embodiments, the epoxy resin blend comprises about 25 wt % of the cycloaliphatic epoxy resin and about 75 wt % of the second epoxy-based resin based on the total weight of the epoxy resin blend. In some embodiments, the epoxy resin blend comprises about 50 wt % of the cycloaliphatic epoxy resin and about 50 wt % of the second epoxy-based resin based on the total weight of the epoxy resin blend. In some embodiments, the epoxy resin blend comprises about 63 wt % of the cycloaliphatic epoxy resin and about 37 wt % of the second epoxy-based resin based on the total weight of the epoxy resin blend.

In some embodiments, the epoxy resin blend comprises about 25 wt % to about 65 wt %, including all ranges, subranges, and values therein (e.g., about 25 wt % to about 30 wt %, about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 25 wt % to about 35 wt %, about 35 wt % to about 45 wt %, about 45 wt % to about 55 wt %, about 55 wt % to about 65 wt %, about 25 wt %, about 50 wt %, about 63 wt %, etc.) of the clycoaliphatic epoxy resin based on the total weight of the epoxy resin blend.

In some embodiments, the first epoxy-based resin and the second epoxy-based resin are present at a 1:1 ratio.

In some embodiments, the at least one curing agent includes an anhydride component. In some embodiments, the anhydride component includes a cyclic anhydride. In some embodiments, the cyclic anhydride includes hexahydrophthalic anhydride (HHPA).

In some embodiments, the at least one curing agent is about 40 wt % to about 55 wt %, including all ranges, subranges, and values therein (e.g., about 40, 41, 42, 43, 44, 45, 46, 47, 48, 49, 50, 51, 52, 53, 54, 55 wt %, about 40 wt % to about 45 wt %, about 45 wt % to about 50 wt %, about 50 wt % to about 55 wt %, etc.) of the unreacted intermediate encapsulant composition based on the total weight of the unreacted intermediate encapsulant composition. In some embodiments, the anhydride component comprises about 41 wt % to about 54 wt %, including all ranges, subranges, and values therein (e.g., about 41, 42, 43, 44, 45, 46, 47, 48, 49, 50, 51, 52, 53, 54 wt %, about 41 wt % to about 45 wt %, about 45 wt % to about 50 wt %, about 50 wt % to about 54 wt %, etc.) of the unreacted intermediate encapsulant composition based on the total weight of the unreacted intermediate encapsulant composition.

In some embodiments, the filled encapsulant composition further comprises about 41 weight percent to about 53.6 weight percent of a curing agent (hardener) based on the total weight of the filled encapsulant composition, including any and all values, ranges and subranges therein. For example, in certain embodiments, the filled encapsulant composition comprises about 41 weight percent to about 53.6 weight percent anhydride based on the total weight of the filled encapsulant composition. In still other embodiments, the filled encapsulant composition comprises 41, 42, 43, 44, 45, 46, 47, 48, 49, 50, 51, 52, 53, 53.6 wt % of anhydride, including any and all values, ranges and subranges therein. As used herein, the percent anhydride is calculated by using the total acid anhydride content, which comprises the total amount of the at least one first anhydride plus the total amount of the at least one second anhydride (to the extent there is any present).

In some embodiments, the filler component is less than about 25 wt %, including all ranges, subranges, and values therein (e.g., about 5 wt %, about 10 wt %, about 15 wt %, about 20 wt %, about 25 wt %, about 20 wt % to about 25 wt %, about 15 wt % to about 20 wt %, about 10 wt % to about 15 wt %, about 5 wt to about 10 wt %, less than 5 wt %, about 10 wt % to about 25 wt %, about 5 wt % to about 20 wt %, etc.) of the unreacted intermediate encapsulant composition based on the total weight of the unreacted intermediate encapsulant composition.

In some embodiments, the filler component has a median particle size in the range of about 50 microns (μ) to about 75 microns (μ), including all ranges, subranges, and values therein (e.g., less than about 74μ, less than about 70μ, less than about 65μ, less than about 60μ, less than about 55μ, less than about 53μ, about 65μ to about 75μ, about 60μ to about 70μ, about 55μ to about 65μ, about 50μ to about 60μ, etc.).

In some embodiments, the filler component is an inorganic component, such as glass particles. In some embodiments, the glass particles are substantially clear, or clear.

In some embodiments, the refractive index-matched filler material comprises a silica glass, more specifically soda lime glass, wherein the glass filler of the curable composition comprises silicon oxide (SiO₂ or silica), sodium oxide (Na₂O or soda ash), and calcium oxide (CaO or lime). In accordance with the invention, smaller amounts of various other compounds may also be present in the filler material, provided the glass filler composition has a refractive index that is <1% of the refractive index for the epoxy-containing component. For example, although not meant to be limiting, the filler material may comprise smaller amounts of the following: dolomite (MgCQ₃), B₂₀₃, MgO, SO₃, K₂O, TiO₂, LizO, ZnO, AhO₃, Na₂B₄O₇ and Fe₂O₃.

In some embodiments, the glass filler is a powder comprising particles ranging from about 0.1 μm to 500 μm in characteristic diameter, including any and all values, ranges and subranges therein. For example, in certain embodiments, the particle size of the soda lime glass filler is 0.1, 0.2, 0.3, 0.4, 0.5, 1, 5, 10, 15, 20, 25, 30, 35, 50, 55, 60, 70, 80, 90, 100, 150, 200, 300, 400, or 500 μm, including any and all values, ranges and subranges therein.

In accordance with the invention, the inventive curable encapsulant, comprises filler material from about 0 weight percent (wt %) to about 25 weight percent (wt %) based on the total weight of the encapsulant composition, including any and all values, ranges and subranges therein. For example, in certain embodiments, the filled encapsulant composition comprises, 0, 1, 2, 3, 4, 5, 6, 7, 8, 9, 10, 11, 12, 13, 14, 15, 16, 17, 18, 19, 20, 21, 22, 23, 24, or 25 wt % of the filler material based on the total weight of the filled encapsulant composition, including any and all values, ranges and subranges therein (e.g., 1 to 10 wt %).

Blends or mixtures of one or more glass filler compositions are contemplated to be within the scope of this disclosure, provided the glass blends or mixtures provide the appropriate index of refraction (i.e. <1% of the index of refraction for the epoxy resin). Preferably, the glass filler content comprises a special high-purity grade, which is substantially free of impurities and inclusions which could absorb or scatter light. For example, typical window glass has a green tint from minor impurities of iron. In some embodiments, the preferred filler is essentially free of iron (<1 ppm). Despite the aforementioned, one of ordinary skill in the art will recognize that the filler composition may be modified with dyes, pigments and diffusing additives to yield customized light transmission characteristics, including diffuse transmission, provided that the appropriate index of refraction is maintained.

In some embodiments, the at least one polyol is selected from glycerol, trimethylol propane (TMP), ethylene glycol, diethylene glycol, propylene glycol, dipropylene glycol, cyclohexane dimethanol, polyethylene glycol, neopentyl glycol (NPG), and mixtures thereof. In some embodiments, the at least one polyol is a polyester polyol resin. In some embodiments, there is one polyol. In some embodiments, there are two polyols. In some embodiments, there are three polyols. In some embodiments, there are more than three polyols. In non-limiting examples, the two polyols are NPG and TMP, or NPG and glycerol, or any other combination of two polyols disclosed above.

In some embodiments, the at least one polyol comprises about 1 wt % to about 10 wt %, including all ranges, subranges, and values therein (e.g., about 1 wt % to about 2 wt %, about 2 wt % to about 3 wt %, about 3 wt % to about 4 wt %, about 4 wt % to about 5 wt %, about 5 wt % to about 6 wt %, about 6 wt % to about 7 wt %, about 7 wt % to about 8 wt %, about 8 wt % to about 9 wt, about 9 wt % to about 10 wt %, about 1 wt % to about 3 wt %, about 3 wt % to about 6 wt %, about 6 wt % to about 9 wt %, about 3 wt % to about 9 wt %, etc.) of the unreacted intermediate encapsulant composition based on the total weight of the unreacted intermediate encapsulant composition.

In some embodiments, the first polyol and the second polyol are present in a ratio of about 2:1 to about 1.75:1, including all ranges, subranges, and values therein (e.g., the ratio may be about 2:1, about 1.95:1, about 1.9:1, about 1.85:1, about 1.8:1, about 1.75:1, about 2:1 to about 1.9:1, about 1.9:1 to about 1.8:1, about 1.8:1 to about 1.75:1, etc.). In a non-limiting example, the first polyol may comprise about 3.4 wt % of the unreacted intermediate encapsulant composition and the second polyol may comprise about 1.7 wt % of the unreacted intermediate encapsulant composition. In another non-limiting example, the first polyol may comprise about 3.4 wt % of the unreacted intermediate encapsulant composition and the second polyol may comprise about 1.95 wt % of the unreacted intermediate encapsulant composition.

In some embodiments, the second polyol comprises greater than 99% of the total polyol content. For purposes of this disclosure, the total polyol content comprises the first polyol plus the at least one second polyol (to the extent there is a second polyol or more). In a non-limiting example, the total polyol content comprises 5.12 wt % of the unreacted intermediate encapsulant composition and the second polyol comprises 99.7 wt % of the total polyol content.

In some embodiments, the filled encapsulant composition further comprises about 3.4 weight percent to about 8.9 weight percent of a polyol based on the total weight of the filled encapsulant composition, including any and all values, ranges and subranges therein. For example, in certain embodiments, the filled encapsulant composition comprises about 2 weight percent to about 6 weight percent of total polyol content based on the total weight of the filled encapsulant composition. In still other embodiments, the encapsulant composition comprises 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9 wt % of total polyol content, based on the total weight of the filled encapsulant composition, including any and all values, ranges and subranges therein. As used herein, total polyol content comprises the total amount of the at least one first polyol and an at least one second polyol (to the extent there is any present).

In some embodiments, the ratio of total equivalents of the anhydride component to total equivalents of the epoxy resin component (A/E ratio) is between about 0.7 and about 1.0, including all ranges, subranges, and values therein (e.g., about 0.7 to about 0.8, about 0.8 to about 0.9, about 0.9 to about 1.0, about 0.7 to about 0.9, about 0.8 to about 1.0, about 0.83 to about 0.94, about 0.83, about 0.92, about 0.93, etc.), preferably about 0.83 and about 0.94.

In some embodiments, the ratio of the equivalents of the anhydride component to total equivalents of OH (A/OH ratio) is between about 1.0 and about 8.0, including all ranges, subranges, and values therein (e.g., about 1.0 to about 2.0, about 2.0 to about 3.0, about 3.0 to about 4.0, about 4.0 to about 5.0, about 0.0 to about 6.0, about 6.0 to about 7.0, about 7.0 to about 8.0, about 1.84 to about 4.3, about 1.88, about 2.1, about 2.8, about 3.3, about 4.3, etc.), preferably between about 1.84 and about 4.3

In some embodiments, any of the above ranges and percentages are contemplated to be within the scope of this disclosure, provided the amount of the anhydride component and the base epoxy resin in the epoxy composition are so proportioned that the ratio of the chemical anhydride equivalents to the chemical epoxy equivalents of the epoxy composition (the A/E ratio) falls within the range between about 0.83 and about 0.94, including all values, ranges and subranges therein; and also provided that the amount of the anhydride component and the OH from the polyol in the epoxy composition are so proportioned that the ratio of the chemical anhydride equivalents to the total OH equivalents of the epoxy composition (the A/OH ratio) falls within the range between about 1.84 and about 4.3, including all values, ranges and subranges therein.

In some embodiments, the unreacted intermediate encapsulant composition includes at least one silane-coupling agent. In some embodiments, the at least one silane-coupling agent is comprising trimethoxy [3 (oxiranylmethoxy) propyl]-silane, amino silanes, epoxy silanes, mercapto silanes, and combinations and mixtures thereof.

In some embodiments, the unreacted intermediate encapsulant composition includes an accelerator. In some embodiments, the accelerator is a catalyst.

In some embodiments, the filled encapsulant composition optionally comprises about 0.5 weight percent to about 3 weight percent of a catalyst based on the total weight of the filled epoxy composition, including all values, ranges and subranges therein. For example, in some embodiments, the filled encapsulant composition comprises 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3 wt % of a catalyst (accelerator or accelerant) based on the total weight of the filled epoxy composition.

In accordance with the invention, when present, the mold release agent is desirably provided in an amount of from about 0.1 weight percent to about 3 weight percent based on the total weight of the filled epoxy composition, including all values, ranges and subranges therein. For example, in some embodiments, the filled encapsulant composition comprises 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3 wt % of a mold release agent based on the total weight of the filled epoxy composition.

By way of example only, in certain embodiments, the curable composition comprises an approximate ratio of about 25 wt % of the filler material and about 75 wt % of the epoxy component (i.e. base epoxy resin, curing agent, and optional ring opening agents, catalysts or modifiers), based on the total weight of the filled composition. By way of further example, in certain embodiments, the curable composition comprises an approximate ratio of about 10 wt % of the filler material and about 90 wt % of the epoxy-containing and curing components, based on the total weight of the filled composition. One of ordinary skill in the art will recognize that other examples of appropriate ratios are contemplated to be within the scope of this disclosure, provided that the desired characteristics are produced (i.e. thermal shock resistance, high RTRAN, excellent electrical properties, low shrinkage, stability and moisture resistance). By way of example, 20:80 wt % (filler:epoxy component), 95:5 wt % (filler:epoxy component), 96:4 wt % (filler:epoxy component), 97:3 wt % (filler:epoxy component), 98:2 wt % (filler:epoxy component), 99:1 wt % (filler:epoxy component), etc., including all ranges, and subranges therein.

In an aspect of the invention, a partially cured molding compound is provided, the partially cured molding compound including an unreacted intermediate encapsulant composition, wherein the unreacted intermediate encapsulant composition is partially cured thereby forming the partially cured molding compound, and wherein the unreacted intermediate encapsulant composition includes: an epoxy resin component including an epoxy resin blend and at least one curing agent, the epoxy resin blend including a mixture of at least a first epoxy-based resin and a second epoxy-based resin, wherein the first epoxy-based resin is a cycloaliphatic epoxy resin; a filler component; and at least one polyol.

In some embodiments, the partially cured molding compound is prepared by B-staging the unreacted intermediate encapsulant composition, thereby forming the partially cured molding compound.

In an aspect of the invention, a cured compound is provided, the cured compound including an unreacted intermediate encapsulant composition, wherein said unreacted intermediate encapsulant composition is cured, thereby forming a cured compound, and wherein the unreacted intermediate encapsulant composition includes: an epoxy resin component including an epoxy resin blend and at least one curing agent, the epoxy resin blend including a mixture of at least a first epoxy-based resin and a second epoxy-based resin, wherein the first epoxy-based resin is a low viscosity cycloaliphatic epoxy resin; a filler component; and at least one polyol.

In illustrative embodiments, a cured product comprising the curable encapsulant composition is provided. In still other embodiments, the inventive encapsulant encapsulates an optoelectronic device comprising a light emitter or a light detector or both. Furthermore, in illustrative embodiments, the clear encapsulants of the present technology are expected to reach, meet and/or achieve the Joint Electron Device Engineering Council (JEDEC) Solid State Technology Association's standardization pertaining to Moisture Sensitivity Levels (MSL) at a MSL level of 2, 2a, or 3 (e.g., MSL 1 test; MSL 2 test; MSL 2a test; MSL 3 test).

In some embodiments, the cured compound is capable of achieving a moisture sensitivity level (MSL) of less than 3, and/or less than 2a, and/or less than 2, and/or less than 1.

In some embodiments, the cured compound is capable of passing a moisture sensitivity (MSL) 1 test, and/or MSL 2 test, and/or MSL 2a test, and/or MSL 3 test.

In some embodiments, the cured compound has a CTE equal to or less than 60 ppm/° C., including all ranges, subranges, and values therein (e.g., 60 ppm/° C., less than 60 ppm/° C., less than 55 ppm/° C., less than 50 ppm/° C., less than 45 ppm/° C., less than 40 ppm/° C., less than 35 ppm/° C., 30 ppm/° C., less than 30 ppm/° C., less than 25 ppm/° C., less than 20 ppm/° C., less than 15 ppm/° C., less than 10 ppm/° C., etc.).

In some embodiments, the cured compound has a regular transmission (RTRAN) of light greater than about 65%, including all ranges, subranges, and values therein (e.g., greater than 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91, 92, 93%, 94%, 95%, 96%, 97%, 98%, and/or 99%) over light wavelengths from about 350 nm to about 2500 nm in specimens 0.5 mm and/or 1.0 mm thick.

In some embodiments, the cured compound has a CTE equal to or less than about 30 ppm/° C. and a regular transmission of light greater than about 65% over light wavelengths from about 350 nm to about 2500 nm in specimens 0.5 mm and/or 1.0 mm thick.

In some embodiments, the cured compound has a CTE of less than about 60 ppm/° C. and an RTRAN greater than about 30% over light wavelengths from about 350 nm to about 2500 nm in specimens 0.5 mm and/or 1.0 mm thick.

In some embodiments, the cured compound has a flexural toughness of greater than about 68 pound-force per square inch (psi), including all ranges, subranges, and values therein (e.g., about 68 psi to about 125 psi, about 68 psi to about 70 psi, about 70 psi to about 75 psi, about 75 psi to about 80 psi, about 80 psi to about 85 psi, about 85 psi to about 90 psi, about 90 psi to about 95 psi, about 95 psi to about 100 psi, about 100 psi to about 105 psi, about 105 psi to about 110 psi, about 110 psi to about 115 psi, about 115 psi to about 120 psi, about 120 psi to about 125 psi, about 68 psi, about 68 psi to about 80 psi, about 80 psi to about 100 psi, about 100 psi to about 125 psi, etc.) as measured by ASTM D790 at 25° C.

In some embodiments, the cured compound has a flexural yield strength of greater than about 18,000 pound-force per square inch (psi), and/or in the range of about 18,800-21,000 psi, according to ASTM D790 at 25° C. at 50% humidity. In some embodiments, the cured compound has a flexural yield strength of about 18,800 psi to about 21,000 psi, including all ranges, subranges, and values therein (e.g., about 18,800, 18,900, 19,000, 19,100, 19,200, 19,300, 19,400, 19,500, 19,600, 19,700, 19,800, 19,900, 20,000, 20,100, 20,200, 20,300, 20,400, 20,500, 20,600, 20,700, 20,800, 20,900, 21,000 psi, etc.).

In some embodiments, the cured compound has an elongation of greater than 5.0%, including all ranges, subranges, and values therein (e.g., greater than about 5, 6, 7, 8, 9, 10, 11, 12, 13, 14, 15, 16, 17, 18, 19, 20, 21, 22, 23, 24, 25, 26, 27, 28 29, 30, 31, 32, 33, 34, 35, 36, 37, 38, 39, 40, 41, 42, 43, 44, 45, 46, 47, 48, 49, 50%, etc.), as measured by ASTM D790 at 25° C.

In some embodiments, the cured compound has a flex strength of greater than about 18,800 pounds per square inch (psi), an elongation of greater than about 5.0%, and a toughness of greater than 68 psi.

In an aspect of the invention, an encapsulant material for electronic components is provided, the encapsulant material for electronic components including a partially cured molding compound, the partially cured molding compound including an unreacted intermediate encapsulant composition, wherein the unreacted intermediate encapsulant composition is partially cured thereby forming the partially cured molding compound, and wherein the unreacted intermediate encapsulant composition includes: an epoxy resin component including an epoxy resin blend and at least one curing agent, the epoxy resin blend including a mixture of at least a first epoxy-based resin and a second epoxy-based resin, wherein the first epoxy-based resin is a low viscosity cycloaliphatic epoxy resin; a filler component; and at least one polyol. Example embodiments of the unreacted intermediate encapsulant composition and the partially cured molding compound of the encapsulant material for electronic components are described hereinabove.

In an aspect of the invention, a device including an optoelectronic element encapsulated by the encapsulant material for electronic components is provided. The encapsulant material for electronic components of the device is described hereinabove.

In an aspect of the invention, an assembly is provided, the assembly including a device, the device including an optoelectronic element encapsulated by the encapsulant material for electronic components. The encapsulant material for electronic components of the assembly is described hereinabove.

In an aspect of the invention, a method of preparing a partially cured molding compound is provided, the method including: a) providing an epoxy component comprising an epoxy resin blend and an anhydride component, wherein the epoxy resin blend comprises a mixture of at least a first epoxy-based resin and a second epoxy-based resin, where the first epoxy-based resin is a cycloaliphatic epoxy resin; b) mixing a filler component with said epoxy component; c) adding at least one polyol thereby producing an unreacted intermediate encapsulant composition; and d) increasing the viscosity of the unreacted intermediate encapsulant composition by partially curing said encapsulant composition to an initial viscosity capable of maintaining said filler component suspended throughout the encapsulant composition, thereby forming a partially cured molding compound. The epoxy component, the epoxy resin blend, the anhydride component, the first epoxy-based resin, the second epoxy-based resin, the cycloaliphatic epoxy resin, the at least one polyol, the unreacted intermediate encapsulant composition, and the partially cured molding compound are described hereinabove.

In an aspect of the invention, a method of preparing a cured device is provided, the method including the steps of:
providing an unreacted intermediate encapsulant composition, said unreacted intermediate encapsulant composition including:
   an epoxy resin component including an epoxy resin blend and at least one curing agent, the epoxy resin blend comprising a mixture of at least a first epoxy-based resin and a second epoxy-based resin, wherein the first epoxy-based resin is a cycloaliphatic epoxy resin;
   a filler component; and
   at least one polyol;
preparing a partially cured molding compound, wherein preparing includes B-staging the unreacted intermediate encapsulant composition;
providing an optoelectronic component;
encapsulating the optoelectronic component with the partially cured molding compound to form a curable device; and
curing the curable device with time or heat, thereby forming a cured device.

The unreacted intermediate encapsulant composition of the method of preparing a cured device is described hereinabove.

In addition to the embodiments disclosed, one of ordinary skill in the art will recognize that alternate compositions of silica glass filler are contemplated to be within the scope of this disclosure, and need not be index-matched to the unfilled epoxy-containing component.

### EXAMPLES

This invention will now be illustrated, but not limited, by reference to the specific embodiments described in the following examples.

### Comparative Example 1, Control 1, and Examples 1 Through 4

Comparative Example 1, Control 1, and Examples 1 through 4 each include triglycidyl isocyanurate (TGIC; epoxy), hexahydrophthalic anhydride (HHPA; anhydride), neopentyl glycol (NPG; polyol), and salines (A/E and A/OH ratios, as defined above, are also indicated in Table 1, below). Control 1 and Examples 1 through 4 further include trimethylol propane (TMP; polyol) and Epalloy (epoxy). Comparative Example 1, Control 1, and Examples 1 and 2 further include a catalyst. Examples 1 through 3 further include a filler. The detailed composition for each of these is shown in Table 1, below.

TABLE 1
Composition of Comparative Example 1, Control 1,
and Examples 1 through 4

| Com- | Comparative | | | | | |
|---|---|---|---|---|---|---|
| ponent | Ex. 1 | Control 1 | Ex. 1 | Ex. 2 | Ex. 3 | Ex. 4 |
| Filler | 0% | 0% | 10% | 5% | 5% | 0% |
| TGIC | 37.41% | 19.65% | 19.65% | 20.85% | 20.85% | 20.85% |
| Epalloy | 0% | 19.65% | 19.65% | 20.85% | 20.85% | 20.85% |
| HHPA | 53.55% | 44.4% | 44.4% | 47% | 47% | 47% |
| NPG | 8.61% | 3.4% | 3.40% | 3.40% | 3.40% | 3.40% |
| TMP | 0% | 1.7% | 1.7% | 1.95% | 1.95% | 1.95% |
| A/OH | 2.11 | 2.8 | 2.8 | 2.8 | 2.8 | 2.8 |
| A/E | 0.92 | 0.92 | 0.92 | 0.92 | 0.92 | 0.92 |
| Silanes | Yes | Yes | Yes | Yes | Yes | Yes |
| Catalyst | Yes | Yes | Yes | Yes | No | No |

### Characterization of Examples 1 Through 4

The characteristics of Examples 1 through 4 are shown in Table 2, below.

TABLE 2
Characteristics of Examples 1 through 4

| | Com- | | | | | |
|---|---|---|---|---|---|---|
| | parative | Control | | | | |
| Characteristic | Ex. 1 | 1 | Ex. 1 | Ex. 2 | Ex. 3 | Ex. 4 |
| 30/60 @ | 1.74 | 0.83 | 1.13 | 1.18 | 1.19 | 1.28 |
| 336 hrs | | | | | | |
| (% weight | | | | | | |
| gain) | | | | | | |
| Tg, TMA, °C | 131 | 145 | 107 | 109 | 113 | 111 |
| RTRAN | 89 | 78 | 85.4 | 85.3 | 84.6 | 88.9 |
| @ 380 nm, | | | | | | |
| 1 mm (%) | | | | | | |
| CTE1 | 66 | 44 | 65 | 65 | 63 | 69 |
| CTE2 | 151 | 107 | 168 | 164 | 162 | 174 |
| Flex strength, | 18.8 | 16 | 19.7 | 19.1 | 16.6 | 19.8 |
| K psi | | | | | | |
| Elongation @ | 4.2 | 1.6 | 5.1 | 4.1 | 4.1 | 6.2 |
| yield, % | | | | | | |
| Toughness, | 53 | 16 | 78 | 51 | 51 | 110 |
| psi | | | | | | |
| Modulus, | 532 | 1,000 | 572 | 567 | 567 | 488 |
| K psi | | | | | | |
| 24 hr boil | ~2.2 | 1.2 | 2.4 | n.d. | n.d. | n.d. |
| 3.2 mm | | | | | | |
| disk weight | | | | | | |
| gain, % | | | | | | |
| Adhesion, | n.d. | n.d. | 21/32/99 | 15/29/97 | 101/99/98 | n.d. |
| tab pull | | | | | | |
| lbs Au/Ag/Cu | | | | | | |

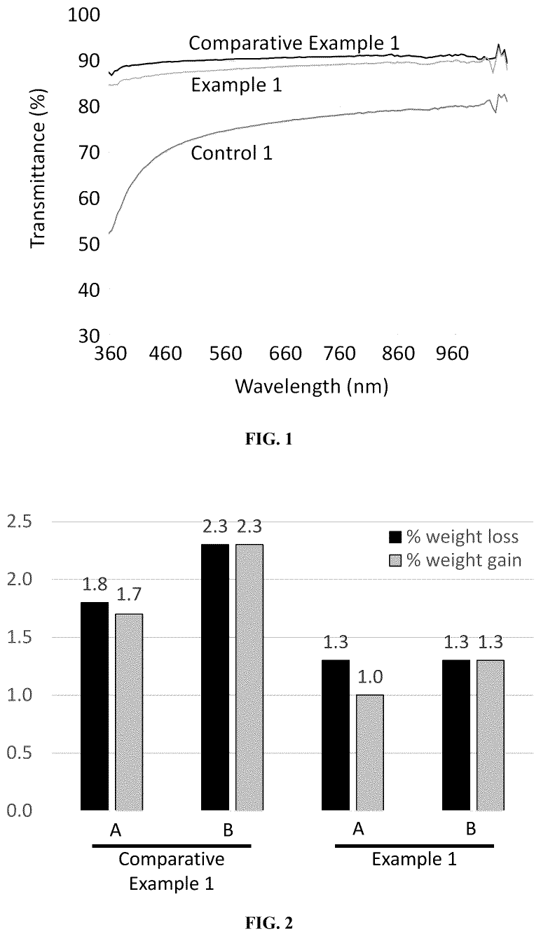

Now referring to FIG. 1, a graphical representation of the relationship between wavelength (nm) and RTRAN of a liquid epoxy resin composition prepared in the manner described herein is shown. Specifically, the RTRAN is shown for Comparative Example 1, Control 1, and Example 1 as a function of wavelength.

Now referring to FIG. 2, a graphical representation of the % weight loss and % weight gain of a liquid epoxy resin composition prepared in the manner described herein is shown. Specifically, the % weight loss and % weight gain are shown for Comparative Example 1 and Example 1.

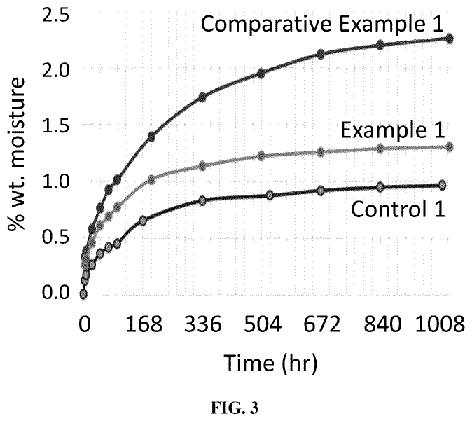

Now referring to FIG. 3, a graphical representation of the % wt. moisture over time of a liquid epoxy resin composition prepared in the manner described herein is shown. Specifically, the % wt. moisture over time is shown for Comparative Example 1, Control 1, and Example 1.

### Examples 5 Through 9

The composition of Examples 5 through 9 is shown in Table 3, below.

TABLE 3
Composition of Examples 5 through 9

| Component | Ex. 5 | Ex. 6 | Ex. 7 | Ex. 8 | Ex. 9 | Ex. 15 |
|---|---|---|---|---|---|---|
| Filler | 0% | 0% | 0% | 0% | 0% | 23% |
| TGIC | 21.50% | 21.91% | 21.91% | 22.09% | 22.31% | 16.85% |
| Epalloy | 21.50% | 21.91% | 21.91% | 22.09% | 22.31% | 16.85% |
| HHPA | 48.8% | 49.8% | 49.8% | 50.3% | 51.0% | 38.32% |
| NPG | 7.82% | 6.0% | 6.0% | 5.14% | 4.0% | 4.0% |
| A/OH | 2.1 | 2.8 | 2.8 | 3.3 | 4.3 | 2.8 |
| A/E | 0.92 | 0.92 | 0.92 | 0.93 | 0.93 | 0.92 |
| Catalyst | No | No | No | No | No | No |
| Silanes | Yes | Yes | Yes | Yes | Yes | Yes |

The characteristics of Examples 5 through 9 are shown in Table 4, below.

TABLE 4
Characteristics of Examples 5 through 9

| Characteristic | Ex. 5 | Ex. 6 | Ex. 7 | Ex. 8 | Ex. 9 | Ex. 15 |
|---|---|---|---|---|---|---|
| 30/60 @ 672 hrs (% weight gain) | 1.47 | 1.43 | 1.42 | n.d. | n.d. | 1.1 |
| 30/60 @ 672 hrs (% lower than control) | 18.3 | 20.6 | n.d. | n.d. | n.d. | n.d |
| 85/85, 168 hrs (% weight gain) | 3.49 | 3.01 | 3 | n.d. | 2.93 | 2.62 |
| 85/85, 168 hrs (% lower than control) | 5.3 | 18 | 18.5 | n.d. | n.d. | n.d. |
| Tg by DSC, dry 4 hrs @ 150C | n.d. | 120, 8 hr | 123 | n.d. | n.d. | n.d. |
| | | @ 150C | | | | |
| Tg by DSC, PC + 168 hrs | n.d. | n.d. | n.d. | n.d. | n.d. | n.d. |
| Flex strength (k psi) | 18.9 | 19.1 | 17 | 19.4 | 19.3 | 20 |
| Flex modulus (k psi) | 495 | 517 | 545 | 498 | 497 | 707 |
| Toughness (psi) | 105 | 103 | 42 | 69 | 69 | 44 |
| Elongation (%) | 5.9 | 5.4 | 3.7 | 5.1 | 5.1 | 3.3 |
| 30/60 @ 336 hrs (% weight gain) | 1.32 | 1.32 | n.d. | n.d. | n.d. | 0.99 |
| Tg by TMA, °C | 105 | 110 | 112 | 118 | 118 | 111 |
| CTE₁, below Tg, ppm/C | 73 | 75 | 70 | 76 | 76 | 68 |
| CTE₂, above Tg, ppm/C | 187 | 186 | 180 | 179 | 179 | 167 |

### Control 2 and Examples 10 Through 14

The composition of Control 2 and Examples 10 through 14 is shown in Table 5, below.

TABLE 5
Composition of Control 2 and Examples 10 through 14

| Component | Control 2 | Ex. 10 | Ex. 11 | Ex. 12 | Ex. 13 | Ex. 14 |
|---|---|---|---|---|---|---|
| Filler | 0% | 0% | 0% | 5% | 0% | 0% |
| TGIC | 39.88% | 22.80% | 23.34% | 23.34% | 23.50% | 23.80% |
| Epalloy | 0% | 22.80% | 23.34% | 23.34% | 23.50% | 23.80% |
| HHPA | 51.88% | 46.95% | 48.20% | 48.20% | 48.60% | 49% |
| Polyol | 8.24% | 7.45% | 5.12% | 5.12% | 4.40% | 3.40% |
| (NPG) | | | | | | |
| Glycerin (% | 99.70% | 99.70% | 99.70% | 99.70% | 99.70% | 99.70% |
| of polyol) | | | | | | |
| A/OH | 1.88 | 1.88 | 2.81 | 2.81 | 3.3 | 4.3 |
| A/E | 0.83 | 0.83 | 0.83 | 0.83 | 0.83 | 0.83 |
| Catalyst | No | No | No | No | No | No |
| Silanes | No | No | No | No | No | No |

The characteristics of Control 2 and Examples 10 through 13 are shown in Table 6, below.

TABLE 6
Characteristics of Control 2 and Examples 10 through 13

| Characteristic | Control 2 | Ex. 10 | Ex. 11 | Ex. 12 | Ex. 13 | Ex. 14 |
|---|---|---|---|---|---|---|
| 30/60 @ 672 hrs (% | 2.26 | 1.83 | 1.73 | n.d. | n.d. | n.d. |
| weight gain) | | | | | | |
| 30/60 @ 672 hrs (% | Control 2 | 18.9 | 23.6 | n.d. | n.d. | n.d. |
| lower than control) | | | | | | |
| 85/85, 168 hrs (% weight | 5.07 | 5.04 | 4.21 | 3.74 | n.d. | n.d. |
| gain) | | | | | | |
| 85/85, 168 hrs (% lower | Control 2 | 0.00% | 17 | 26.3 | n.d. | n.d. |
| than control) | | | | | | |
| Tg by DSC, dry 4 hrs @ | 149 | 120? | 120 | 122 | n.d. | n.d. |
| 150C | | | | | | |
| Tg by DSC, PC + 168 hrs | 119 | n.d. | n.d. | n.d. | n.d. | n.d. |
| Flex strength (k psi) | 19.3 | 17.6 | 20.8 | 20.3 | 19.4 | n.d. |
| Flex modulus (k psi) | 533 | 558 | 535 | 534 | 498 | n.d. |
| Toughness (psi) | 67 | 84 | 89 | 89 | 69 | n.d. |
| Elongation (%) | 4.8 | 4 | 5.5 | 5.4 | 5.1 | n.d. |
| 30/60 @ 336 hrs (% | 1.83 @ 312; | 1.57 @ 312; | 1.47@ | n.d. | n.d. | n.d. |
| weight gain) | 1.83 @312 | 1.48 @ 312 | 312 | | | |
| Tg by TMA, °C | 136 | 99 | 106 | 111 | 117 | n.d. |
| CTE₁, below Tg, ppm/C | 68 | 66 | 71 | 69 | 76 | n.d. |
| CTE₂, above Tg, ppm/C | 154 | 167 | 182 | 179 | 179 | n.d. |

Additional experiments were performed with the following catalysts: Hycat AO-4 and Zinc Octoate.

The following controls and example compositions were made by “B-staging” the unreacted intermediate encapsulate composition, thereby forming the partially cured molding compound. In other words, the epoxy composition disclosed herein can be heat cured for a short period of time and then cooled to prevent complete polymerization of the resin system, thereby producing a partially cured (e.g., less than 10%) solid composition.

### Control 3 and Examples 16 and 17

The composition of Control 3 and Examples 16 and 17 is shown in Table 7, below.

TABLE 7
Composition of Examples 16 and 17

| Component | Control 3 | Ex. 16 | Ex. 17 |
|---|---|---|---|
| Filler | 0% | 0% | 0% |
| TGIC | 21.91% | 21.87% | 21.87% |
| Epalloy | 21.91% | 21.87% | 21.87% |
| HHPA | 49.8% | 49.72% | 49.72% |
| NPG | 6.0% | 6.0% | 6.0% |
| A/OH | 2.8 | 2.8 | 2.8 |
| A/E | 0.92 | 0.92 | 0.92 |
| Silanes | Yes | Yes | Yes |
| Catalyst | No | Yes | Yes |
| (amount/%) | | (0.15%) | (0.15%) |

The following tests were performed to test different catalysts for moisture absorption and changes compared to control 3.

The above epoxy compositions were cured and then samples 1 mm thick were prepared for the JEDEX MSL testing. Cured ⅛ in thick specimens were used for TMA analysis. And cured ⅛ in thick bars were used for ASTM D790.

The characteristics of Control 3 and Examples 16 and 17 are shown in Table 8, below.

TABLE 8
Characteristics of Control 3 and Examples 16 and 17

| Characteristic | Control 3 | Ex. 16 | Ex. 17 |
|---|---|---|---|
| 30/60 @ 672 hrs (% | 1.42 | 1.44 | 1.35 |
| weight gain) | | | |
| 30/60 @ 672 hrs (% | — | 1.4% | 4.9% |
| lower than control) | | Higher | |
| 85/85, 168 hrs (% weight | 3 | 3.35 | 2.95 |
| gain) | | | |
| 85/85, 168 hrs (% lower | — | 11.6% | 1.6% |
| than control) | | Higher | |
| Flex strength (k psi) | 19.9 | 20 | 20.2 |
| Flex modulus (k psi) | 520 | 515 | 530 |
| Toughness (psi) | 103 | 99 | 101 |
| Elongation (%) | 6.3 | 5.8 | 5.7 |
| Tg by TMA, °C | 113 | 108 | 110 |
| CTE₁, below Tg, ppm/C | 74 | 72 | 70 |
| CTE₂, above Tg, ppm/C | 185 | 180 | 180 |

The surprising and unexpected aspect of the present technology concerns the lower moisture absorption percentage based on the JEDEC MSL testing at 1 mm. And elongation percentage from ASTM D790 flex testing from the exchange of TGIC resin in the system for Epalloy resin. The lower moisture absorption and better elongation is desirable to the optoelectronic manufacturing community for its ability to pass a higher JEDEC MSL level.

Achieving these desired moisture resistance levels without having to add filler such as soda lime glass or silica is surprising and makes the invention unique because it retains better flexural performance compared to an epoxy composite system.

In certain examples, although not limiting, the optoelectronic element is an optical semiconductor element and the optoelectronic device is an optical semiconductor device using the optoelectronic element, wherein the composition encapsulating the optical semiconductor element has a high light transmittance even within a broad temperature range together with an internal stress reducing effect. Non-limiting examples of such an article, device or assembly include, for example, light emitting diode displays and microdisplays, automotive sensors, semiconductor sensors, photovoltaic cells, liquid crystal displays (LCD), RGB (red, green, blue) LED panels/matrices, plasma displays, and microelectromechanical (MEMS) devices, lenses, waveguides, light pipes, transmitters, fiber optic components, photodetectors, and receivers.

In another aspect of the invention, a method is provided for making a high-performance encapsulant comprising the steps of (1) preparing an unfilled epoxy resin matrix (2) uniformly mixing in a glass filler to form a filled, curable encapsulant composition; (3) encapsulating a device with the filled, curable encapsulant composition; and (4) curing the filled encapsulant composition with time or heat. In some embodiments, the filled epoxy composition is optionally heated using a temperature in the range of 90° C. and 200° C. to cure (i.e. thermally cured). In some embodiments, the duration of the curing may be between about 0.5 and 8 hours.

In some embodiments, while not required, the epoxy composition is capable of being “B-staged”. In other words, the epoxy composition disclosed herein can be heat cured for a short period of time and then cooled to prevent complete polymerization of the resin system, thereby producing a partially cured (i.e. less than 10%) solid composition. The partially cured epoxy is subsequently heated to reactivate polymerization and complete the curing cycle. B-staged epoxies, and methods related thereto, are well-known in the art, and are described, for example, in U.S. Pat. Nos. 3,849,383, 6,989,412 and 7,125,917.

The surprising and unexpected aspect of the present technology concerns the reduction of straight-forward nature of the solution to obtaining a clear encapsulant with high RTRAN and low CTE, which, although desired by the optoelectronic manufacturing community at large, has never before been materialized. In this regard, the present inventors have discovered that by very closely matching the refractive index of the epoxy matrix, e.g., an average refractive index of 1.50-1.52, with soda lime glass filler having nearly identical refractive index (within 1%) of the nominal refractive index of the epoxy matrix, the desired regular transmission (RTRAN) is preserved even at high concentrations of soda lime glass filler (>50%), and is suitable to reduce Coefficient of Thermal Expansion (CTE) to desirable levels (for example, <45 ppm/° C., nominally 30 ppm/° C.). One of ordinary skill in the art will recognize that unfilled epoxy typically exhibits about 80 ppm/° C., while filled epoxy composite can be as low as 17 ppm/° C. However, there is a long-felt need in the market for an epoxy-resin molding composition that comprises a combination of a low CTE, high RTRAN and low MSL.

It is surprising that these desired results were achieved using soda lime glass, which has CTE equal to 8.6×10·6 K-1 at 20° C., which is much higher than borosilicate glass (which has a CTE of about 3.3×10·6 K-1 at 20° C., almost ⅓ of a soda lime glass). When compared to sodalime glass, it is well known in the art that borosilicate glass provides a greater resistance to thermal changes and chemical corrosion, while soda-lime glass is not as resistant to high temperatures and sudden thermal changes. The results reported herein were surprising and unexpected, because one of ordinary skill in the art would not expect soda lime glass to impart the desired characteristics (low CTE, high RTRAN and low MSL), and as such would be unlikely to try use soda lime glass to produce a high-performance curable epoxy. It is also surprising that the addition of soda lime glass in the present invention is able to achieve these desired levels because typical molded epoxies have indices of refraction greater than about 1.54 and therefore require an inorganic filler with index of refraction that is much higher than soda lime glass (1.515).

As will be readily appreciated by persons having ordinary skill in the art, properties tested in the examples may vary significantly depending upon the particular composition of the epoxy resin component, filler component, and polyol, and the foregoing examples are nonlimiting.

The following patent applications are expressly incorporated herein by reference: U.S. Pat. Nos. 3,849,383, 6,989,412, 7,125,917, and 10,611,911.

The present disclosure is not to be limited in terms of the particular embodiments described in this application. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

Where one or more ranges are referred to throughout this specification, each range is intended to be a shorthand format for presenting information, where the range is understood to encompass each discrete point within the range as if the same were fully set forth herein.

As will be understood by one skilled in the art, for any and all purposes, particularly in terms of providing a written description, all ranges disclosed herein also encompass any and all possible subranges and combinations of subranges thereof. Where one or more ranges are referred to throughout this specification, each range is intended to be a shorthand format for presenting information, where the range is understood to encompass each discrete point within the range as if the same were fully set forth herein.

As will also be understood by one skilled in the art, all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 filler materials refers to groups having 1, 2, or 3 filler materials, and so forth.

While various aspects and illustrative embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

All references or publications cited herein are incorporated by reference in their entireties and for all purposes to the same extent as if each individual publication, patent, or patent application was specifically and individually incorporated by reference in its entirety for all purposes. Subject matter incorporated by reference is not considered to be an alternative to any claim limitations, unless otherwise explicitly indicated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or article that “comprises”, “has”, “includes” or “contains” one or more steps or elements possesses those one or more steps or elements, but is not limited to possessing only those one or more steps or elements. Likewise, a step of a method or an element of an article that “comprises”, “has”, “includes” or “contains” one or more features possesses those one or more features, but is not limited to possessing only those one or more features.

Terms like “obtainable” or “definable” and “obtained” or “defined” are used interchangeably. This, for example, means that, unless the context clearly dictates otherwise, the term “obtained” does not mean to indicate that, for example, an embodiment must be obtained by, for example, the sequence of steps following the term “obtained” though such a limited understanding is always included by the terms “obtained” or “defined” as a preferred embodiment.

Approximating language, as used herein throughout disclosure, may be applied to modify any quantitative representation that could permissibly vary without resulting in a change in the basic function to which it is related. Accordingly, a value modified by a term or terms, such as “about” or “substantially,” is not limited to the precise value specified. For example, these terms can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. In some instances, the approximating language may correspond to the precision of an instrument for measuring the value.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by persons having ordinary skill in the art to accomplish the same objectives. Accordingly, this disclosure and the appended claims are intended to cover all such further and alternative aspects and embodiments as fall within the true spirit and scope of the invention.

1. An unreacted intermediate encapsulant composition, comprising:
an epoxy resin component comprising an epoxy resin blend and at least one curing agent, the epoxy resin blend comprising a mixture of at least a first epoxy-based resin and a second epoxy-based resin, wherein the first epoxy-based resin is a cycloaliphatic epoxy resin;
a filler component; and
at least one polyol.

2. The composition of claim 1, wherein one or more of:
(i) the filler component is an inorganic component;
(ii) the filler component is less than 25 wt %, based on the total weight of the intermediate encapsulant composition; and
(iii) the filler component has a median particle size in the range of about 50 to 75 microns (μ).

3. (canceled)

4. The composition of claim 1, wherein the second epoxy-based resin is selected from the group consisting of triglycidyl isocyanurate (TGIC), Bisphenol A (BPA), and combinations or variants thereof.

5. The composition of claim 1, wherein one or more of:
(i) the cycloaliphatic epoxy resin is monocyclic;
(ii) the cycloaliphatic epoxy resin has a viscosity of less than 1000 cps, and/or about 700 cps to about 900 cps, at 25° C.; and
(iii) the cycloaliphatic epoxy resin is cycloaliphatic glycidyl ester.

6-7. (canceled)

8. The composition of claim 1, wherein the epoxy resin blend comprises about 25 wt % of the cycloaliphatic epoxy resin and about 75 wt % of the second epoxy-based resin based on the total weight of the epoxy resin blend.

9. (canceled)

10. The composition of claim 1, wherein the at least one curing agent comprises an anhydride component, wherein the anhydride component preferably comprises a cyclic anhydride, and wherein the cyclic anhydride preferably comprises hexahydrophthalic anhydride (HHPA).

11. The composition of claim 1, wherein the at least one polyol is a polyester polyol resin.

12. The composition of claim 1, wherein the at least one polyol is selected from the group consisting of glycerol, trimethylol propane, ethylene glycol, diethylene glycol, propylene glycol, dipropylene glycol, cyclohexane dimethanol, polyethylene glycol, neopentyl glycol (NPG), and mixtures thereof.

13. The composition of claim 1, wherein one or more of:
(i) the at least one curing agent comprises about 40 wt % to about 55 wt % of the unreacted intermediate encapsulant composition based on the total weight of the unreacted intermediate encapsulant composition;
(ii) the anhydride component comprises about 41 wt % to about 54 wt % of the unreacted intermediate encapsulant composition based on the total weight of the unreacted intermediate encapsulant composition; and
(iii) the at least one polyol comprises 1 wt % to 10 wt % of the unreacted intermediate encapsulant composition based on the total weight of the unreacted intermediate encapsulant composition.

14-16. (canceled)

17. The composition of claim 1, wherein the ratio of total equivalents of the anhydride component to total equivalents of the epoxy resin component (A/E ratio) is between about 0.7 and about 1, and the ratio of the equivalents of the anhydride component to total equivalents of OH (A/OH ratio) is between about 1.0 and about 8.0.

18. The composition of claim 1, further comprising at least one silane-coupling agent selected from the group comprising trimethoxy [3 (oxiranylmethoxy) propyl]-silane, amino silanes, epoxy silanes, mercapto silanes, and combinations and mixtures thereof.

19. The composition of claim 18 further comprising an accelerator.

20. A partially cured molding compound comprising the unreacted intermediate encapsulant composition of claim 1, wherein the unreacted intermediate encapsulant composition is partially cured, thereby forming the partially cured molding compound.

21. The partially cured molding compound according to claim 20, wherein said partially cured molding compound is prepared by B-staging the unreacted intermediate encapsulant composition to form the partially cured molding compound.

22. A cured compound comprising the unreacted intermediate encapsulant composition of claim 1, wherein the unreacted intermediate encapsulant composition is cured, thereby forming a cured compound, said cured compound comprising a regular transmission of light (RTRAN) greater than about 65%, and more preferably greater than about 80%, over light wavelengths from about 350 nm to about 2500 nm when measured in a 1.0 mm thick sample of said compound.

23. The cured compound of claim 22, wherein one or more of:
(i) the cured compound is capable of achieving a moisture sensitivity level (MSL) of less than 3;
(ii) the cured compound is capable of passing a moisture sensitivity level (MSL) 1 test, MSL 2 test, MSL 2a test, and/or MSL 3 test;
(iii) the cured compound has a flexural yield strength of greater than about 18,000 pound-force per square inch (psi), and/or in the range of about 18,800-21,000 psi, according to ASTM D790 at 25° C. and 50% humidity;
(iv) the cured compound has an elongation of greater than 5.0% as measured by ASTM D638 at 25° C.; and
(v) the cured compound has a flexural toughness of greater than about 68 pound-force per square inch (psi) as measured by ASTM D790 at 25° C.

24-30. (canceled)

31. A method of preparing a partially cured molding compound comprising:
a) providing an epoxy component comprising an epoxy resin blend and an anhydride component, wherein the epoxy resin blend comprises a mixture of at least a first epoxy-based resin and a second epoxy-based resin, where the first epoxy-based resin is a cycloaliphatic epoxy resin;
b) mixing a filler component with said epoxy component;
c) adding at least one polyol thereby producing an unreacted intermediate encapsulant composition; and
d) increasing the viscosity of the unreacted intermediate encapsulant composition by partially curing said unreacted intermediate encapsulant composition to an initial viscosity capable of maintaining said filler component suspended throughout the unreacted intermediate encapsulant composition, thereby forming a partially cured molding compound.

32. The method of claim 31, wherein one or more of:
(i) the filler component is less than 25 wt %, based on the total weight of the unreacted intermediate encapsulant composition;
(ii) the filler component has a median particle size in the range of about 50 to 75 microns (μ);
(iii) the second epoxy-based resin is selected from the group consisting of triglycidyl isocyanurate (TGIC), Bisphenol A (BPA), and combinations or variants thereof;
(iv) the cycloaliphatic epoxy resin is monocyclic;
(v) the at least one curing agent comprises an anhydride component, wherein the anhydride component preferably comprises a cyclic anhydride, and wherein the cyclic anhydride preferably comprises HH; and
(vi) the at least one polyol is a polyester polyol resin.

33-37. (canceled)

38. The method of claim 31, wherein one or more of:
(i) the at least one polyol is selected from the group consisting of glycerol, trimethylol propane, ethylene glycol, diethylene glycol, propylene glycol, dipropylene glycol, cyclohexane dimethanol, polyethylene glycol, neopentyl glycol (NPG), and mixtures thereof;
(ii) the at least one curing agent comprises about 40 wt % to about 55 wt % of the encapsulant composition based on the total weight of the encapsulant composition; the anhydride component comprises about 41 wt % to about 54 wt % of the encapsulant composition based on the total weight of the encapsulant composition; and/or the polyol comprises about 1 wt % to about 10 wt % of the encapsulant composition based on the total weight of the encapsulant composition; and
(iii) the ratio of total equivalents of the anhydride component to total equivalents of the epoxy resin component (A/E ratio) is between about 0.7 and about 1, and the ratio of the equivalents of the anhydride component to total equivalents of OH (A/OH ratio) is between about 1.0 and about 8.0.

39-40. (canceled)

41. A method of preparing a cured device, comprising the steps of:
providing an unreacted intermediate encapsulant composition, said unreacted intermediate encapsulant composition comprising:
an epoxy resin component comprising an epoxy resin blend and at least one curing agent, the epoxy resin blend comprising a mixture of at least a first epoxy-based resin and a second epoxy-based resin, wherein the first epoxy-based resin is a cycloaliphatic epoxy resin;
a filler component; and
at least one polyol;
preparing a partially cured molding compound, wherein preparing comprises B-staging the unreacted intermediate encapsulant composition;
providing an optoelectronic component;
encapsulating the optoelectronic component with the partially cured molding compound to form a curable device; and
curing the curable device with time or heat, thereby forming a cured device.
